(19) United States
(12) Patent Application Publication
(10) Pub. No.: US 2005/0072338 A1
(43) Pub. Date: Apr. 7, 2005

(54) Colour-and/or effect-producing powder slurries, method for production thereof and a mixing system for colour-and/or effect-producing slurries

(76) Inventors: Hans-Joachim Weintz, Senden (DE); Dieter Weber, Overath (DE)

Correspondence Address: BASF CORPORATION;ANNE GERRY SABOURIN, 26701 TELEGRAPH ROAD, SOUTHFIELD, MI, 48034-2442, US

(21) Appl. No.: 10/381,560

(22) PCT Filed: Oct. 31, 2001
(86) PCT No.: PCT/EP01/12558

(30) Foreign Application Priority Data
Oct. 31, 2000 (DE) 100 53 931.9

(51) Int. Cl. C08K 5/00

(52) U.S. Cl. 106/493

(57) ABSTRACT

Color and/or effect powder slurries preparable by mixing (A) a powder slurry clearcoat material with (B) at least one color and/or effect powder slurry, or alternatively (A) a color and/or effect powder slurry with (B) at least one color and/or effect powder slurry having a different shade and/or optical effect than the powder slurry (A); processes for preparing the color and/or effect powder slurries, and a mixer system and a modular system based on the color and/or effect powder slurries (A) and (B) and, if appropriate, on the powder slurry clearcoat material (A).

The present invention relates to novel color and/or effect powder slurries. The present invention additionally relates to a novel process for preparing color and/or effect powder slurries. The present invention further relates to a novel mixer system and modular system for color and/or effect powder slurries. The present invention relates not least to a novel process for the subsequent tinting of color and/or effect powder slurries.

Color and/or effect powder slurries, i.e., aqueous dispersions of color and/or effect powder coating materials, have been known for a long time.

For instance, the Japanese patent application JP 53 109 540 A1 (Derwent reference 78800A/44) discloses a color and/or effect powder slurry, which it does not specify in any greater detail, for the preparation of a color and/or effect basecoat.

The German OPI document DE 27 10 421 A1 discloses a powder slurry which comprises metallic effect pigments and is based on amine-neutralized acrylate copolymers and melamine resins or on polyesters and epoxy resins. The known powder slurry provides smooth, glossy, metallic coatings.

The Japanese patent application JP 02 014 776 A2 discloses a multicoat system comprising basecoat and clearcoat, whose basecoat is prepared from a color and/or effect powder slurry based on hydroxyl-containing acrylate copolymers and blocked polyisocyanates.

The American patent U.S. Pat. No. 5,379,947 A discloses cosolvent-free, color and/or effect powder slurries based, for example, on hydroxyl-containing acrylate copolymers and blocked polyisocyanates or glycidyl-containing acrylate copolymers and 1,12-dodecanedicarboxylic acid. The color and/or effect powder slurries may be used either to prepare primers, i.e., surfacer coats or antistonechip primers, or to prepare basecoats.

Like the corresponding powder coating materials, color and/or effect powder slurries have the advantage over conventional or aqueous, wet coating materials imparting color and/or effect of complete or virtually complete freedom from organic solvents. Relative to the powder coating materials, they possess the essential advantage that they can be stored, transported and applied in the same way as the wet coating materials and, unlike powder coating materials, do not require any special equipment.

Like the powder coating materials, following application and the evaporation of the water, they are present in the form of a thin layer on the substrate and are melted so as to form a continuous powder coating film. Curing takes place during or after the melting of the powder layer. The minimum temperature for the cure is preferably above the melting range of the powder, so that melting and curing are separate from one another. This has the advantage that, owing to their comparatively low viscosity, the powder melt flows out well before curing begins.

The color and/or effect powder slurries known to date, and the processes for preparing them, have an essential disadvantage which, despite the technical advantages they possess, hinders their broad use.

Thus it is impossible to adjust and/or correct the shade by mixing or tinting steps; instead, the shade is fixed solely by the original components weighed out. This means that the color, and/or effect pigments have to traverse the entire preparation process or part of it, which may lead to damage to the pigments. Or else the pigments are mixed into a powder slurry clearcoat material, thereby frequently giving rise to problems with the dispersion of the color and/or effect pigments in the powder slurry.

Whether the finished color and/or effect powder slurry and the coating produced from it will ultimately also have the desired shade and/or optical effect is dependent on numerous different process parameters and on the respective implementation of the preparation processes, so that it becomes extremely difficult to determine the cause of off-specification batches. It is obvious that the powder slurries which deviate from the predetermined specifications in their composition and in their profile of performance properties, especially as regards the shades and/or the optical effects, cannot give coatings which are to specification.

Moreover, the existing preparation processes are uneconomic, since a color and/or effect powder slurry of a particular shade and/or optical effect must be prepared in a comparatively large quantity, even if only small amounts of it are required.

Mixer systems for aqueous coating materials (wet coating materials) are known from the patent applications DE 41 10 520 A1, EP 0 471 972 A1, EP 0 578 645 A1, EP 0 614 951 A1 or EP 0 698 773 A1.

They permit the preparation to demand of aqueous coating materials in precisely matchable shades and optical effects. These known mixer systems comprise essentially water-free color and/or effect base colors and at least one aqueous, pigment-free mixing varnish. These mixer systems and the coating materials prepared from them have a capacity for variation which means that they essentially meet the continually increasing requirements of the market. These known mixer systems have therefore been able to establish themselves in the form of modular systems, especially in automotive refinishing, where they are used to produce small quantities of color and/or effect coating materials. In order to make effective use of the potential of these modular systems, the material compositions of the color and/or effect coating materials are determined with the aid of a paint mixing formula system.

To date, however, color and/or effect powder slurries have not been used in the context of such modular systems.

In the context of the present invention, the term “module” denotes a standardized, ready-to-use commercial product whose profile of performance properties is adapted precisely to the profiles of properties of the other modules and supplements them, so that overall the modules may be combined to form a modular system.

It is an object of the present invention to provide new color and/or effect powder slurries from which the disadvantages of the prior art are now absent and whose composition and profile of technical properties instead correspond precisely to the respective predetermined specifications, especially as regards the shades and/or the optical effects. At the same time, the intention is to make complete use of the color and/or effect potential of the pigments in the coatings produced from the new powder slurries. Moreover, the intention is that the new powder slurries should be simple to prepare.

Furthermore, the present invention was based on the object of finding a new process for preparing color and/or effect powder slurries which no longer has the disadvantages of the prior art but which instead makes it possible without great effort to prepare powder slurries of different shades and/or optical effects, the color and/or effect powder slurries always complying fully with the predetermined specification. Moreover, the new process should make it possible to make subsequent adjustments, in line with the specification, to color and/or effect powder slurries that have been prepared but which deviate from the predetermined specifications, so that off-specification batches are reduced greatly in number or even done away with entirely.

Additionally, it was an object of the present invention to find a new mixer system for powder slurries which permits not only the preparation of color and/or effect powder slurries but also the subsequent adjustment of their shades and/or their optical effects.

An object of the present invention not least was to find a new modular system for color and/or effect powder slurries which permits the preparation of color and/or effect powder slurries and also the subsequent adjustment of their shades and/or their optical effects on the basis of a paint mixing formula system.

Accordingly, we have found the novel color and/or effect powder slurries preparable by mixing
(A) a powder slurry clearcoat material with
(B) at least one color and/or effect powder slurry, or alternatively
(A) a color and/or effect powder slurry with
(B) at least one color and/or effect powder slurry having a different shade and/or optical effect than the powder slurry (A).

In the text below, the novel color and/or effect powder slurries are referred to as “powder slurries of the invention”.

We have also found the novel process for preparing color and/or effect powder slurries, which involves mixing
(A) a powder slurry clearcoat material with
(B) at least one color and/or effect powder slurry, or alternatively
(A) a color and/or effect powder slurry with
(B) at least one color and/or effect powder slurry having a different shade and/or optical effect than the powder slurry (A).

In the text below, the novel process for preparing color and/or effect powder slurries is referred to as the “preparation process of the invention”.

Furthermore, we have found the novel process for the subsequent adjustment of the shades and/or the optical effects of color and/or effect powder slurries, which involves mixing
(A) a color and/or effect powder slurry with
(B) at least one color and/or effect powder slurry having a different shade and/or optical effect than the powder slurry (A).

In the text below, the novel process for the subsequent adjustment of the shades and/or the optical effects of color and/or effect powder slurries is referred to as the “tinting process of the invention”.

Furthermore, we have found the novel mixer system for preparing color and/or effect powder slurries and/or for subsequently adjusting their shades and/or their optical effects, which comprises
(A) a color and/or effect powder slurry and
(B) at least one further color and/or effect powder slurry having a different shade and/or optical effect than the powder slurry (A),
   and which is referred to below as the “mixer system of the invention”.

Not least, we have found the novel modular system for preparing color and/or effect powder slurries and/or for subsequently adjusting their shades and/or their optical effects, which comprises
(I) an effect module comprising a color and/or effect powder slurry (A), and
(II) at least one further effect module, comprising a color and/or effect powder slurry (B) having a different shade and/or optical effect than the powder slurry (A), and also
(III) a paint mixing formula system (C) and which is referred to below as the “modular system of the invention”.

The powder slurries of the invention are preparable by mixing a powder slurry clearcoat material (A) with at least one color and/or effect powder slurry. Or else a color and/or effect powder slurry (A) is mixed with at least one color and/or effect powder slurry (B) having a different shade and/or optical effect than the powder slurry (A). It is preferred to employ the second variant, in which color and/or effect powder slurries (A) and (B) are mixed with one another.

The optical effects in question comprise, in particular, metallic effects and/or dichroic optical effects (cf. Römpp Lexikon Lacke und Druckfarben, Georg Thieme Verlag, 1998, page 176, “Effect pigments” and pages 380 and 381, “Metal oxide-mica pigments” to “Metal pigments”).

The powder slurry clearcoat material (A), the color and/or effect powder slurry (A) and the color and/or effect powder slurry (B) are curable thermally and/or with actinic radiation.

If they are thermally curable, they may be thermally externally crosslinking or thermally self-crosslinking, especially externally crosslinking. In the context of the present invention, the term “self-crosslinking” denotes the capacity of a binder to enter into crosslinking reactions with itself. A prerequisite for this is that the binders already include both kinds of complementary reactive functional groups necessary for crosslinking, or reactive functional groups which are able to react “with themselves”. Externally crosslinking, on the other hand, refers to those powder slurries of the invention in which one kind of the complementary reactive functional groups is present in the binder and the other kind in a curing agent or crosslinking agent. For further details, reference is made to Römpp Lexikon Lacke und Druckfarben, Georg Thieme Verlag, Stuttgart, N.Y., 1998, “Curing”, pages 274 to 276, especially page 275, bottom.

In the context of the present invention, actinic radiation is electromagnetic radiation such as near infrared, visible light, UV radiation or X-rays, especially UV radiation, or corpuscular radiation such as electron beams.

Where thermal curing and curing with actinic radiation are employed at the same time, the terms used also include dual cure and dual-cure powder slurries.

In the context of the preparation of the thermally curable powder slurries of the invention, preferably
a thermally curable powder slurry clearcoat material (A) is mixed with at least one thermally curable color and/or effect powder slurry (B), or alternatively
a thermally curable color and/or effect powder slurry (A) is mixed with at least one thermally curable color and/or effect powder slurry (B).

In the context of the preparation of the powder slurries of the invention curable with actinic radiation, it is preferred to mix
a powder slurry clearcoat material (A) curable with actinic radiation with at least one color and/or effect powder slurry (B) curable with actinic radiation, or alternatively
a color and/or effect powder slurry (A) curable with actinic radiation with at least one color and/or effect powder slurry (B) curable with actinic radiation.

In the context of the preparation of the dual-cure powder slurries of the invention, it is preferred to mix
a powder slurry clearcoat material (A) curable with actinic radiation with at least one thermally curable color and/or effect powder slurry (B),
a powder slurry clearcoat material (A) curable with actinic radiation with at least one color and/or effect dual-cure powder slurry (B),
a thermally curable powder slurry clearcoat material (A) with at least one color and/or effect powder slurry (B) curable with actinic radiation,
a thermally curable powder slurry clearcoat material (A) with at least one color and/or effect dual-cure powder slurry (B),
a dual-cure powder slurry clearcoat material (A) with at least one thermally curable color and/or effect powder slurry (B),
a dual-cure powder slurry clearcoat material (A) with at least one color and/or effect powder slurry (B) curable with actinic radiation, or
a dual-cure powder slurry clearcoat material (A) with at least one color and/or effect dual-cure powder slurry (B),
   or alternatively
a powder slurry (A) curable with actinic radiation with at least one thermally curable color and/or effect powder slurry (B),
a powder slurry (A) curable with actinic radiation with at least one color and/or effect dual-cure powder slurry (B),
a thermally curable powder slurry (A) with at least one color and/or effect powder slurry (B) curable with actinic radiation,
a thermally curable powder slurry (A) with at least one color and/or effect dual-cure powder slurry (B),
a dual-cure powder slurry (A) with at least one thermally curable color and/or effect powder slurry (B),
a dual-cure powder slurry (A) with at least one color and/or effect powder slurry (B) curable with actinic radiation, or
a dual-cure powder slurry (A) with at least one color and/or effect dual-cure powder slurry (B).

In accordance with the invention it is of advantage in this context if the powder slurry clearcoat materials (A) and the color and/or effect powder slurries (A) and (B) comprise the same constituents except for the color and/or effect pigments; especially the same binders.

Of the powder slurries of the invention and variants of the preparation process of the invention that have been set out above, those which are advantageous are those wherein color and/or effect powder slurries (A) are mixed with at least one color and/or effect powder slurry (B).

The preferred variants of the preparation process of the invention that have been set out above are also used in the context of the tinting process of the invention, preferably with the aid of the mixer system of the invention and of the modular system of the invention. For this purpose, the mixer system of the invention and the modular system of the invention are provided with the corresponding appropriate powder clearcoat materials or color and/or effect powder slurries (A) and with the corresponding appropriate color and/or effect powder slurries (B).

The color and/or effect powder slurries (A) and (B) for use in accordance with the invention contain at least one finely divided dimensionally stable constituent, i.e., a powder coating material, as disperse phase and an aqueous medium as continuous phase. The same applies to the powder clearcoat materials (A) for use in accordance with the invention; these merely contain no hiding color and/or effect pigments and fillers. Accordingly, the comments below regarding the color and/or effect powder slurries (A) and (B) apply mutatis mutandis to the powder slurry clearcoat materials (A).

The finely divided dimensionally stable constituent or powder coating material of the color and/or effect powder slurry may be solid and/or of high viscosity. In the context of the present invention, “of high viscosity” means that the particles behave essentially like solid particles under the customary and known conditions of the preparation, storage and use of powder slurries. Preferably, the powder coating material is solid.

Moreover, the individual particles of the finely divided constituent are dimensionally stable. In the context of the present invention, “dimensionally stable” means that, under the customary and known conditions of the storage and use of powder slurries, the particles agglomerate only slightly if at all and/or break down into smaller particles only slightly if at all, instead essentially retaining their original form even under the effect of shear forces.

Preferably, the solids content of the color and/or effect powder slurry is from 10 to 80, more preferably from 15 to 75, with particular preference from 20 to 70, with very particular preference from 25 to 70, and in particular from 30 to 65% by weight, based in each case on the color and/or effect powder slurry.

Preferably, the average particle size of the finely divided dimensionally stable constituents of the color and/or effect powder slurry is from 0.8 to 40 μm, more preferably from 0.8 to 20 μm, and with particular preference from 2 to 6 μm. The average particle size is the 50% median determined by the laser diffraction method, i.e., 50% of the particles have a diameter ≦the median and 50% of the particles have a diameter ≧the median.

The particle size reaches its upper limit when the size of the particles means that they are no longer able to flow out completely on baking, and the film leveling is adversely effected as a result. 40 μm is considered a reasonable upper limit, since above this particle size the rinsing ducts of the highly sensitive application apparatus may be expected to become blocked.

The color and/or effect powder slurry is preferably free from organic solvents (cosolvents). In the context of the present invention this means that it has a residual volatile solvent content of <1% by weight, preferably <0.5% by weight, and with particular preference <0.2% by weight. In accordance with the invention, it is especially advantageous if the residual content is below the gas chromatography detection limit.

In a first embodiment which is preferred in accordance with the invention, the finely divided dimensionally stable constituent of the color and/or effect powder slurry comprises at least one color and/or effect pigment; i.e., the totality of the pigments used are present in the dispersed powder coating particles.

In a second embodiment which is preferred in accordance with the invention, the color and/or effect powder slurry comprises at least one pigment-free finely divided constituent or powder coating material and at least one pulverulent, color and/or effect pigment; i.e., all pigments are present as a separate solid phase. Regarding their particle size, the comments made above apply analogously.

In a third embodiment which is preferred in accordance with the invention, the color and/or effect powder slurry comprises at least one dispersed powder coating material which comprises part of the pigments used while the other part of the pigments is present in the form of a separate solid phase. In this case, the fraction which is present in the powder coating particles may comprise the majority, i.e., more than 50%, of the pigments used. However, it is also possible for less than 50% to be present in the powder coating particles. Regarding the particle sizes, the comments made above apply here analogously.

The question of which variant of the color and/or effect powder slurry to be used in accordance with the invention is given preference is guided in particular by the nature of the pigments and/or by the process by which the particular color and/or effect powder slurry used is prepared. In the majority of cases, the first preferred embodiment affords particular advantages, and so is particularly preferred in accordance with the invention.

The pigments may comprise organic or inorganic compounds. On the basis of this large number of suitable pigments, therefore, the color and/or effect powder slurry for use in accordance with the invention ensures a universal breadth of use and makes it possible to realize a large number of shades and optical effects.

Examples of suitable effect pigments are metal flake pigments such as commercial aluminum bronzes, aluminum bronzes chromated in accordance with DE 36 36 183 A1, and commercial stainless steel bronzes, and also nonmetallic effect pigments, such as pearlescent pigments and interference pigments, for example, platelet-shaped effect pigments based on iron oxide having a shade from pink to brownish red, or liquid-crystalline effect pigments. For further details, reference is made to Römpp Lexikon Lacke und Druckfarben, Georg Thieme Verlag, 1998, page 176, “Effect pigments” and pages 380 and 381, “Metal oxide-mica pigments” to “Metal pigments”, and to the patent applications and patents DE 36 36 156 A1, DE 37 18 446 A1, DE 37 19 804 A1, DE 39 30 601 A1, EP 0 068 311 A1, EP 0 264 843 A1, EP 0 265 820 A1, EP 0 283 852 A1, EP 0 293 746 A1, EP 0 417 567 A1, U.S. Pat. No. 4,828,826 A or U.S. Pat. No. 5,244,649 A.

Examples of suitable inorganic color pigments are white pigments such as titanium dioxide, zinc white, zinc sulfide or lithopones; black pigments such as carbon black, iron-manganese black or spinel black; color pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chrome orange; or yellow iron oxide, nickel titanium yellow, chrome titanium yellow, cadmium sulfide, cadmium zinc sulfide, chrome yellow or bismuth vanadate.

Examples of suitable organic color pigments are monoazo pigments, disazo pigments, anthraquinone pigments, benzimidazole pigments, quinacridone pigments, quinophthalone pigments, dicetopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments or aniline black.

For further details, reference is made to Römpp Lexikon Lacke und Druckfarben, Georg Thieme Verlag, 1998, pages 180 and 181, “Iron blue pigments” to “Black iron oxide”, pages 451 to 453, “Pigments” to “Pigment volume concentration”, page 563, “Thioindigo pigments”, page 567, “Titanium dioxide pigments”, pages 400 and 467, “Naturally occurring pigments”, page 459, “Polycyclic pigments”, page 52, “Azomethine pigments”, “Azo pigments”, and page 379, “Metal complex pigments”.

Furthermore, the color and/or effect powder slurry may comprise organic and inorganic fillers, which like the pigments may be present inside and outside the dispersed powder coating particles; the comments made regarding the pigments apply analogously here.

Examples of suitable organic and inorganic fillers are chalk, calcium sulfates, barium sulfate, silicates such as talc or kaolin, silicas, oxides such as aluminum hydroxide or magnesium hydroxide, or organic fillers such as textile fibers, cellulose fibers, polyethylene fibers, polyacrylonitrile powders, polyamide powders or wood flour. For further details, reference is made to Römpp Lexikon Lacke und Druckfarben, Georg Thieme Verlag, 1998, pages 250 ff., “Fillers”. Further examples of suitable fillers are disclosed in the German patent application DE 196 06 706 A1, column 8, lines 30 to 64. They are preferably used in the amounts specified therein.

The pigments and fillers may also be present in an ultrafine, nonhiding form.

The proportion of the pigments, including the fillers, in the color and/or effect powder slurries for use in accordance with the invention may vary very widely and is guided by the requirements of the individual case, in particular by the optical effect to be established and/or the hiding power of the particular pigments used. Preferably, the pigment content is from 0.5 to 80, more preferably from 0.8 to 75, with particular preference from 1.0 to 70, with very particular preference from 1.2 to 65, and in particular from 1.3 to 60% by weight, based in each case on the solids of the color and/or effect powder slurry.

In addition to the pigments described above, the color and/or effect powder slurry for use in accordance with the invention may comprise organic dyes in molecularly disperse distribution.

These dyes in molecularly disperse distribution may be present either in the dispersed powder coating particles or in the continuous phase of the color and/or effect powder slurry for use in accordance with the invention.

However, they may also be present in the dispersed powder coating particles and in the continuous phase. In this case, the fraction present in the powder coating particles may comprise the majority, i.e., more than 50%, of the organic dyes used. However, it is also possible for less than 50% to be present in the powder coating particles. The distribution of the organic dyes between the phases may correspond to the thermodynamic equilibrium which results from the solubility of the organic dyes in the phases. However, the distribution may also be far removed from the thermodynamic equilibrium.

Suitable organic dyes are all those which are soluble in the sense described above in the color and/or effect powder slurry for use in accordance with the invention. Lightfast organic dyes are highly suitable. Lightfast organic dyes with little or no tendency to migrate from the coatings produced from the powder slurries of the invention are especially suitable. The migration tendency may be estimated by the skilled worker on the basis of his or her general knowledge in the art and/or determined with the aid of simple preliminary rangefinding tests, in tinting tests, for example.

The amount of the molecularly dispersely distributed organic dyes in the color and/or effect powder slurry may vary extremely widely and is guided primarily by the color and the hue to be produced and by the amount of pigments and/or fillers present.

As an essential constituent, the powder coating material comprises at least one binder.

The binders are oligomeric and polymeric resins. Oligomers are resins containing from at least 2 to 15 monomer units in their molecule. In the context of the present invention, polymers are resins containing at least 10 repeating monomer units in their molecule. For further details of these terms, reference is made to Römpp Lexikon Lacke und Druckfarben, Georg Thieme Verlag, Stuttgart, N.Y., 1998, “Oligomers”, page 425.

It is of advantage in accordance with the invention if the minimum film formation temperature of the binders is at least 0° C., preferably at least 10, with particular preference at least 15, with very particular preference at least 20, and in particular at least 25° C. The minimum film formation temperature can be determined by drawing down the aqueous dispersion of the binder on to a glass plate, using a coating bar, and heating it in a gradient oven. The temperature at which the pulverulent layer forms a film is referred to as the minimum film formation temperature. For further details, reference is made to Römpp Lexikon Lacke und Druckfarben, Georg Thieme Verlag, Stuttgart, N.Y., 1998, “Minimum film formation temperature”, page 391.

Examples of suitable binders are random, alternating and/or block linear and/or branched and/or comb addition (co)polymers of ethylenically unsaturated monomers, or polyaddition resins and/or polycon-densation resins. For further details of these terms, reference is made to Römpp Lexikon Lacke und Druckfarben, Georg Thieme Verlag, Stuttgart, N.Y., 1998, page 457, “Polyaddition” and “Polyaddition resins (polyadducts)”, and also pages 463 and 464, “Polycondensates”, “Polycondensation” and “Polycondensation resins”, and also pages 73 and 74, “Binders”.

Examples of suitable addition (co)polymers are (meth)acrylate (co)polymers or partially saponified polyvinyl esters, especially (meth)acrylate copolymers.

Examples of suitable polyaddition resins and/or polycondensation resins are polyesters, alkyds, polyurethanes, polylactones, polycarbonates, poly-ethers, epoxy resins, epoxy resin-amine adducts, polyureas, polyamides, polyimides, polyester-polyurethanes, polyether-polyurethanes or polyester-polyether-polyurethanes, especially epoxy resins.

The self-crosslinking binders of the thermally curable powder coating materials and of the dual-cure powder coating materials comprise reactive functional groups which are able to enter into crosslinking reactions with groups of their kind or with complementary reactive functional groups. The externally crosslinking binders comprise reactive functional groups which are able to enter into crosslinking reactions with complementary reactive functional groups that are present in crosslinking agents. Examples of suitable complementary reactive functional groups for use in accordance with the invention are summarized in the following overview. In the overview, the variable R stands for an acyclic or cyclic aliphatic, an aromatic and/or an aromatic-aliphatic (araliphatic) radical; the variables R′ and R″ stand for identical or different aliphatic radicals or are linked to one another to form an aliphatic or heteroaliphatic ring.

Overview: Examples of Complementary Functional Groups

Binder and crosslinking agent
or
Crosslinking agent and binder

| | |
|---|---|
| —SH | —C(O)—OH |
| —NH₂ | —C(O)—O—C(O)— |
| —OH | —NCO |
| —O—(CO)—NH—(CO)—NH₂ | —NH—C(O)—OR |
| —O—(CO)—NH₂ | —CH₂—OH |
| >NH | —CH₂—O—R |
| | —NH—CH₂—O—R |
| | —NH—CH₂—OH |
| | —N(—CH₂—O—R)₂ |
| | —NH—C(O)—CH(—C(O)OR)₂ |
| | —NH—C(O)—CH(—C(O)OR)(—C(O)—R) |
| | —NH—C(O)—NR′NR″ |
| | >Si(OR)₂ |

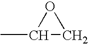

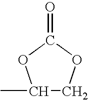

—C(O)—OH

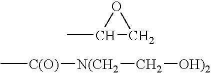

The selection of the complementary groups in each case is guided firstly by the fact that during the preparation, storage, application and melting of the powder slurries of the invention they should not enter into any unwanted reactions, in particular no premature crosslinking, and/or, if appropriate, should not disrupt or inhibit curing with actinic radiation, and secondly by the temperature range within which crosslinking is to take place.

In the case of the powder slurries of the invention, it is preferred to employ crosslinking temperatures of from 60 to 180° C. Use is therefore made preferably of binders containing thio, hydroxyl, N-methylolamino, N-alkoxymethylamino, imino, carbamate, allophanate, epoxy or carboxyl groups, preferably hydroxyl or epoxy groups, in particular epoxy groups, on the one hand, and preferably crosslinking agents containing anhydride, carboxyl, epoxy, blocked isocyanate, urethane, methylol, methylol ether, siloxane, carbonate, amino, hydroxyl and/or beta-hydroxyalkylamide groups, preferably epoxy, hydroxy, beta-hydroxyalkylamide, blocked and unblocked isocyanate, urethane or alkoxymethylamino groups, with particular preference epoxy or hydroxyl groups, in particular phenolic hydroxyl groups, on the other.

In the case of self-crosslinking color and/or effect powder slurries, the binders contain in particular methylol, methylol ether and/or N-alkoxymethylamino groups.

Complementary reactive functional groups especially suitable for use in the color and/or effect powder slurries for use in accordance with the invention are
carboxyl groups on the one hand and epoxy groups and/or beta-hydroxyalkylamide groups on the other,
hydroxyl groups on the one hand and blocked isocyanate, urethane or alkoxymethylamino groups on the other, and
epoxy groups on the one hand and phenolic hydroxyl groups on the other.

The functionality of the binders in respect of the reactive functional groups described above may vary very widely and depends in particular on the desired crosslinking density and/or on the functionality of the crosslinking agents employed in each case. In the case of carboxyl-containing binders, for example, the acid number is preferably from 10 to 100, more preferably from 15 to 80, with particular preference from 20 to 75, with very particular preference from 25 to 70, and, in particular, from 30 to 65 mg KOH/g. Alternatively, in the case of hydroxyl-containing binders, the OH number is preferably from 15 to 300, more preferably from 20 to 250, with particular preference from 25 to 200, with very particular preference from 30 to 150, and in particular from 35 to 120 mg KOH/g. Alternatively, in the case of binders containing epoxy groups, the epoxide equivalent weight is preferably from 400 to 2500, more preferably from 420 to 2200, with particular preference from 430 to 2100, with very particular preference from 440 to 2000, and, in particular, from 440 to 1900.

The complementary reactive functional groups described above can be incorporated into the binders in accordance with the customary and known methods of polymer chemistry. This can be done, for example, by incorporating monomers which carry the corresponding reactive functional groups, and/or with the aid of polymer-analogous reactions.

Examples of suitable olefinically unsaturated monomers containing reactive functional groups are
a1) monomers which carry at least one hydroxyl, amino, alkoxymethylamino, carbamate, allophanate or imino group per molecule, such as
   hydroxyalkyl esters of acrylic acid, methacrylic acid or another alpha,beta-olefinically unsaturated carboxylic acid, which are derived from an alkylene glycol which is esterified with the acid, or which are obtainable by reacting the alpha,beta-olefinically unsaturated carboxylic acid with an alkylene oxide such as ethylene oxide or propylene oxide, especially hydroxyalkyl esters of acrylic acid, methacrylic acid, ethacrylic acid, crotonic acid, maleic acid, fumaric acid or itaconic acid, in which the hydroxyalkyl group contains up to 20 carbon atoms, such as 2-hydroxyethyl, 2-hydroxypropyl, 3-hydroxy-propyl, 3-hydroxybutyl, 4-hydroxybutyl acrylate, methacrylate, ethacrylate, crotonate, maleate, fumarate or itaconate; or hydroxy-cycloalkyl esters such as 1,4-bis(hydroxy-methyl)cyclohexane, octahydro-4,7-methano-1H-indenedimethanol or methylpropanediol mono-acrylate, monomethacrylate, monoethacrylate, monocrotonate, monomaleate, monofumarate or monoitaconate; reaction products of cyclic esters, such as epsilon-caprolactone and these hydroxyalkyl or hydroxycycloalkyl esters;
   olefinically unsaturated alcohols such as allyl alcohol;
   polyols such as trimethylolpropane monoallyl or diallyl ether or pentaerythritol monoallyl, diallyl or triallyl ether;
   reaction products of acrylic acid and/or methacrylic acid with the glycidyl ester of an alpha-branched monocarboxylic acid having 5 to 18 carbon atoms per molecule, especially a Versatic® acid, or instead of the reaction product an equivalent amount of acrylic and/or methacrylic acid, which is then reacted during or after the polymerization reaction with the glycidyl ester of an alpha-branched mono-carboxylic acid having 5 to 18 carbon atoms per molecule, especially a Versatic® acid;
   aminoethyl acrylate, aminoethyl methacrylate, allylamine or N-methyliminoethyl acrylate;
   N,N-di(methoxymethyl)aminoethyl acrylate or methacrylate or N,N-di(butoxymethyl)aminopropyl acrylate or methacrylate;
   (meth)acrylamides such as (meth)acrylamide, N-methyl-, N-methylol-, N,N-dimethylol-, N-methoxymethyl-, N,N-di(methoxymethyl)-, N-ethoxymethyl- and/or N,N-di(ethoxyethyl)-(meth)acrylamide;
   acryloyloxy- or methacryloyloxyethyl, -propyl or -butyl carbamate or allophanate; further examples of suitable monomers containing carbamate groups are described in the U.S. Pat. No. 3,479,328, U.S. Pat. No. 3,674,838, U.S. Pat. No. 4,126,747, U.S. Pat. No. 4,279,833 or U.S. Pat. No. 4,340,497;
a2) monomers which carry at least one acid group per molecule, such as
   acrylic acid, methacrylic acid, ethacrylic acid, crotonic acid, maleic acid, fumaric acid or itaconic acid;
   olefinically unsaturated sulfonic or phosphonic acids or their partial esters;
   mono(meth)acryloyloxyethyl maleate, succinate or phthalate; or
   vinylbenzoic acid (all isomers), alpha-methylvinylbenzoic acid (all isomers) or vinylbenzenesulfonic acid (all isomers);
a3) monomers containing epoxy groups, such as the glycidyl ester of acrylic acid, methacrylic acid, ethacrylic acid, crotonic acid, maleic acid, fumaric acid or itaconic acid, or allyl glycidyl ether.

They are preferably used to prepare (meth)acrylate copolymers, especially ones containing glycidyl groups.

Higher-functional monomers of the type described above are generally used in minor amounts. For the purposes of the present invention, minor amounts of higher-functional monomers are those amounts which do not lead to crosslinking or gelling of the addition copolymers, in particular of the (meth)acrylate copolymers, unless the specific desire is to prepare crosslinked polymeric microparticles.

Examples of suitable monomer units for introducing reactive functional groups into polyesters or polyester-polyurethanes are 2,2-dimethylolethyl- or -propylamine blocked with a ketone, the resulting ketoxime group being hydrolyzed again following incorporation; or compounds containing two hydroxyl groups or two primary and/or secondary amino groups and also at least one acid group, in particular at least one carboxyl group and/or at least one sulfonic acid group, such as dihydroxypropionic acid, dihydroxysuccinic acid, dihydroxybenzoic acid, 2,2-dimethylolacetic acid, 2,2-dimethylolpropionic acid, 2,2-dimethylolbutyric acid, 2,2-dimethylolpentanoic acid, α,δ-diaminovaleric acid, 3,4-diaminobenzoic acid, 2,4-diaminotoluenesulfonic acid or 2,4-diaminodiphenyl ether sulfonic acid.

One example of introducing reactive functional groups by way of polymer-analogous reactions is the reaction of hydroxyl-containing resins with phosgene, resulting in resins containing chloroformate groups, and the polymer-analogous reaction of the chloroformate-functional resins with ammonia and/or primary and/or secondary amines to give resins containing carbamate groups. Further examples of suitable methods of this kind are known from the U.S. Pat. No. 4,758,632 A, U.S. Pat. No. 4,301,257 A or U.S. Pat. No. 2,979,514 A.

The binders of the color and/or effect dual-cure powder slurries further comprise on average at least one, preferably at least two, group(s) having at least one bond per molecule that can be activated with actinic radiation. The binders of the color and/or effect powder slurries curable with actinic radiation contain at least two of these groups.

For the purposes of the present invention, a bond that can be activated with actinic radiation is a bond which on exposure to actinic radiation becomes reactive and, with other activated bonds of its kind, enters into addition polymerization reactions and/or crosslinking reactions which proceed in accordance with free-radical and/or ionic mechanisms. Examples of suitable bonds are carbon-hydrogen single bonds or carbon-carbon, carbon-oxygen, carbon-nitrogen, carbon-phosphorus or carbon-silicon single bonds or double bonds. Of these, the carbon-carbon double bonds are particularly advantageous and are therefore used with very particular preference in accordance with the invention. For the sake of brevity, they are referred to below as “double bonds”.

Accordingly, the group which is preferred in accordance with the invention comprises one double bond or two, three or four double bonds. If more than one double bond is used, the double bonds can be conjugated. In accordance with the invention, however, it is of advantage if the double bonds are present in isolation, in particular each being present terminally, in the group in question. It is of particular advantage in accordance with the invention to use two double bonds or, in particular, one double bond.

If more than one group that can be activated with actinic radiation is used on average per molecule, the groups are structurally different from one another or of the same structure.

If they are structurally different from one another, this means, in the context of the present invention, that use is made of two, three, four or more, but especially two, groups that can be activated with actinic radiation, these groups deriving from two, three, four or more, but especially two, monomer classes.

Examples of suitable groups are (meth)acrylate, ethacrylate, crotonate, cinnamate, vinyl ether, vinyl ester, dicyclopentadienyl, norbornenyl, isoprenyl, isopropenyl, allyl or butenyl groups; dicyclo-pentadienyl, norbornenyl, isoprenyl, isopropenyl, allyl or butenyl ether groups; or dicyclopentadienyl, norbornenyl, isoprenyl, isopropenyl, allyl or butenyl ester groups, but especially acrylate groups.

Preferably, the groups are attached to the respective parent structures of the binders via urethane, urea, allophanate, ester, ether and/or amide groups, but in particular via ester groups. Normally, this occurs as a result of customary and known polymer-analogous reactions such as, for instance, the reaction of pendant glycidyl groups with the olefinically unsaturated monomers described above that contain an acid group, of pendant hydroxyl groups with the halides of these monomers, of hydroxyl groups with isocyanates containing double bonds such as vinyl isocyanate, methacryloyl isocyanate and/or 1-(1-isocyanato-1-methylethyl)-3-(1-methylethenyl)benzene (TMI® from the company CYTEC), or of isocyanate groups with the above-described hydroxyl-containing monomers.

Alternatively, in the dual-cure powder coating materials, it is possible to employ mixtures of purely thermally curable binders and binders that are curable purely with actinic radiation.

The material composition of the binders does not basically have any special features; rather, suitable binders include
all the binders envisaged for use in powder clearcoat slurries curable thermally and/or with actinic radiation that are described in U.S. Pat. No. 4,268,542 A or U.S. Pat. No. 5,379,947 A and in patent applications DE 27 10 421 A1, DE 195 40 977 A1, DE 195 18 392 A1, DE 196 17 086 A1, DE 196 13 547 A1, DE 196 18 657 A1, DE 196 52 813 A1, DE 196 17 086 A1, DE 198 14 471 A1, DE 198 41 842 A1 or DE 198 41 408 A1, in German Patent Application DE 199 08 018.6 or DE 199 08 013.5, unpublished at the priority date of the present specification, or in European Patent Application EP 0 652 264 A1;
all the binders envisaged for use in dual-cure clearcoats that are described in patent applications DE 198 35 296 A1, DE 197 36 083 A1 or DE 198 41 842 A1; or
all the binders envisaged for use in thermally curable powder coating materials and described in German Patent Application DE 42 22 194 A1, in the product information bulletin from BASF Lacke+Farben AG, “Pulverlacke”, 1990, in the BASF Coatings AG brochure “Pulverlacke, Pulverlacke für industrielle Anwendungen”, January 2000, or in the German patent DE 196 32 426 C2.

Suitable additional binders for the dual-cure powder coating materials, or sole binders for the powder coating materials curable with actinic radiation, are the binders envisaged for use in UV-curable clearcoats and powder clearcoats and described in European Patent Applications EP 0 928 800 A1, EP 0 636 669 A1, EP 0 410 242 A1, EP 0 783 534 A1, EP 0 650 978 A1, EP 0 650 979 A1, EP 0 650 985 A1, EP 0 540 884 A1, EP 0 568 967 A1, EP 0 054 505 A1 or EP 0 002 866 A1, in German Patent Applications DE 197 09 467 A1, DE 42 03 278 A1, DE 33 16 593 A1, DE 38 36 370 A1, DE 24 36 186 A1 or DE 20 03 579 B1, in the international patent applications WO 97/46549 or WO 99/14254, or in U.S. Pat. No. 5,824,373 A, U.S. Pat. No. 4,675,234 A, U.S. Pat. No. 4,634,602 A, U.S. Pat. No. 4,424,252 A, U.S. Pat. No. 4,208,313 A, U.S. Pat. No. 4,163,810 A, U.S. Pat. No. 4,129,488 A, U.S. Pat. No. 4,064,161 A or U.S. Pat. No. 3,974,303 A.

The preparation of the binders also has no special features as to its method, but takes place with the aid of the customary and known methods of polymer chemistry, as described in detail, for example, in the patent documents recited above.

Further examples of suitable preparation processes for (meth)acrylate copolymers are described in European Patent Application EP 0 767 185 A1, in German Patents DE 22 14 650 B1 or DE 27 49 576 B, and In U.S. Pat. No. 4,091,048 A1, U.S. Pat. No. 3,781,379 A, U.S. Pat. No. 5,480,493 A, U.S. Pat. No. 5,475,073 A or U.S. Pat. No. 5,534,598 A, or in the standard work Houben-Weyl, Methoden der organischen Chemie, 4th Edition, Volume 14/1, pages 24 to 255, 1961. Suitable reactors for the copolymerization are the customary and known stirred vessels, cascades of stirred vessels, tube reactors, loop reactors or Taylor reactors, as described, for example, in the patent applications DE 1 071 241 B1, EP 0 498 583 A1 or DE 198 28 742 A1 or in the article by K. Kataoka in Chemical Engineering Science, Volume 50, No. 9, 1995, pages 1409 to 1416.

The preparation of polyesters and alkyd resins is also described, for example, in the standard work Ullmanns Encyklopädie der technischen Chemie, 3rd Edition, Volume 14, Urban & Schwarzenberg, Munich, Berlin, 1963, pages 80 to 89 and pages 99 to 105, and also in the following books: “RÉsines Alkydes-Polyesters” by J. Bourry, Paris, Dunod, 1952, “Alkyd Resins” by C. R. Martens, Reinhold Publishing Corporation, New York, 1961, and “Alkyd Resin Technology” by T. C. Patton, Interscience Publishers, 1962.

The preparation of polyurethanes and/or acrylated polyurethanes is also described, for example, in the patent applications EP 0 708 788 A1, DE 44 01 544 A1 or DE 195 34 361 A1.

The binder content of the color and/or effect powder slurries may vary very widely and depends in particular on whether they are thermally self-crosslinking. In this case, it can be preferably from 20 to 99.5, more preferably from 25 to 99.2, with particular preference from 30 to 99, with very particular preference from 35 to 98.8, and, in particular, from 40 to 98.7% by weight, based on the solids of the color and/or effect powder slurry. In the other cases, the binder content is preferably from 10 to 80, more preferably from 15 to 75, with particular preference from 20 to 70, with very particular preference from 25 to 65, and, in particular, from 30 to 60% by weight, based on the solids of the color and/or effect powder slurry.

The externally crosslinking powder coating materials curable thermally, or thermally and with actinic radiation, comprise at least one crosslinking agent which comprises the reactive functional groups complementary to the reactive functional groups of the binders. Consequently, the skilled worker is easily able to select the crosslinking agents suitable for a given powder coating material.

Examples of suitable crosslinking agents are
amino resins, as described for example in Römpp Lexikon Lacke und Druckfarben, Georg Thieme Verlag, 1998, page 29, “Amino resins”, in the textbook “Lackadditive” [Additives for coatings] by Johan Bieleman, Wiley-VCH, Weinheim, New York, 1998, pages 242 ff., in the book “Paints, Coatings and Solvents”, second, completely revised edition, eds. D. Stoye and W. Freitag, Wiley-VCH, Weinheim, N.Y., 1998, pages 80 ff., in patents U.S. Pat. No. 4,710,542 A1 or EP 0 245 700 A1, and in the article by B. Singh and coworkers “Carbamylmethylated Melamines, Novel Crosslinkers for the Coatings Industry” in Advanced Organic Coatings Science and Technology Series, 1991, Volume 13, pages 193 to 207;
carboxyl-containing compounds or resins, as described for example in the patent DE 196 52 813 A1 or 198 41 408 A1, especially 1,12-dodecanedioic acid;
epoxy-containing compounds or resins, as described for example in patents EP 0 299 420 A1, DE 22 14 650 B1, DE 27 49 576 B1, U.S. Pat. No. 4,091,048 A or U.S. Pat. No. 3,781,379 A;
blocked polyisocyanates, as described for example in the patents U.S. Pat. No. 4,444,954 A1, DE 196 17 086 A1, DE 196 31 269 A1, EP 0 004 571 A1 or EP 0 582 051 A1;
beta-hydroxyalkylamides such as N,N,N′,N′-tetrakis(2-hydroxyethyl)adipamide or N,N,N′,N′-tetrakis(2-hydroxypropyl)adipamide;
tris(alkoxycarbonylamino)triazines, as described in U.S. Pat. No. 4,939,213 A1, U.S. Pat. No. 5,084,541 A, U.S. Pat. No. 5,288,865 A or EP 0 604 922 A1; and/or
phenolic hardeners, as described for example in the German patent DE 196 32 426 C2, page 5 line 48 to page 6 line 64.

The crosslinking agent content of the color and/or effect powder slurries may likewise vary very widely and depends on the requirements of the individual case, in particular on the number of complementary reactive functional groups present in the binders and crosslinking agents. It is preferably from 1 to 50, more preferably from 2 to 45, with particular preference from 3 to 40, with very particular preference from 4 to 35, and, in particular, from 5 to 30% by weight, based on the solids of the color and/or effect powder slurry.

In addition to the above-described pigments, binders and, if appropriate, crosslinking agents, the color and/or effect powder slurry for use in accordance with the invention may further comprise at least one additive. Depending on its physicochemical properties and/or its function, said additive may be present essentially in the dispersed powder coating particles or essentially in the continuous phase.

Examples of suitable additives are
thermally curable reactive diluents such as positionally isomeric diethyloctanediols or hydroxyl-containing hyperbranched compounds or dendrimers;
reactive diluents curable with actinic radiation, such as those described in Römpp Lexikon Lacke und Druckfarben, Georg Thieme Verlag, Stuttgart, N.Y., 1998, on page 491 under the headword “Reactive diluents”;
crosslinking catalysts such as dibutyltin dilaurate, lithium decanoate or zinc octoate, amine-blocked organic sulfonic acids, quaternary ammonium compounds, amines, imidazole and imidazole derivatives such as 2-styrylimidazole, 1-benzyl-2-methylimidazole, 2-methylimidazole and 2-butylimidazole, as described in Belgian Patent No. 756,693, or phosphonium catalysts such as ethyltriphenylphosphonium iodide, ethyltriphenylphosphonium chloride, ethyltriphenylphosphonium thiocyanate, ethyltriphenylphosphonium acetate-acetic acid complex, tetrabutylphosphonium iodide, tetrabutylphosphonium bromide and tetrabutylphosphonium acetate-acetic acid complex, as are described, for example, in U.S. Pat. No. 3,477,990 A or U.S. Pat. No. 3,341,580 A;
thermally labile free-radical initiators such as organic peroxides, organic azo compounds or C—C-cleaving initiators such as dialkyl peroxides, peroxocarboxylic acids, peroxodicarbonates, peroxide esters, hydroperoxides, ketone peroxides, azodinitriles or benzpinacol silyl ethers;
photoinitiators, as described in Römpp Chemie Lexikon, 9th expanded and revised edition, Georg Thieme Verlag, Stuttgart, Vol. 4, 1991, or in Römpp Lexikon Lacke und Druckfarben, Georg Thieme Verlag, Stuttgart, 1998, pages 444 to 446;
antioxidants such as hydrazines and phosphorus compounds;
UV absorbers such as triazines and benzotriphenol;
light stabilizers such as HALS compounds, benzotriazoles or oxalanilides;
leveling agents;
free-radical scavengers and polymerization inhibitors such as organic phosphites or 2,6-di-tert-butylphenol derivatives;
slip additives;
defoamers;
emulsifiers, especially nonionic emulsifiers such as alkoxylated alkanols and polyols, phenols and alkylphenols, or anionic emulsifiers such as alkali metal salts or ammonium salts of alkanecarboxylic acids, alkanesulfonic acids, and sulfo acids of alkoxylated alkanols and polyols, phenols and alkylphenols;
wetting agents such as siloxanes, fluorine compounds, carboxylic monoesters, phosphoric esters, polyacrylic acids and their copolymers, or polyurethanes, as described, for example, in patent application DE 198 35 296 A1, especially in conjunction with the polyurethane-based associative thickeners described below;
adhesion promoters such as tricyclodecanedimethanol;
film-forming auxiliaries such as cellulose derivatives;
flame retardants;
devolatilizers such as diazadicycloundecane or benzoin;
water retention agents;
free-flow aids;
rheology control additives (thickeners), such as those known from patent applications WO 94/22968, EP 0 276 501 A1, EP 0 249 201 A1 or WO 97/12945; crosslinked polymeric microparticles, such as those disclosed, for example, in EP 0 008 127 A1; inorganic sheet silicates such as aluminum-magnesium silicates, sodium-magnesium and sodium-magnesium-fluorine-lithium sheet silicates of the montmorillonite type; silicas such as Aerosils; or synthetic polymers having ionic and/or associative groups, such as polyvinyl alcohol, poly(meth)acrylamide, poly(meth)acrylic acid, polyvinylpyrrolidone, styrene-maleic anhydride copolymers or ethylene-maleic anhydride copolymers and their derivatives or polyacrylates; or polyurethane-based associative thickeners, as described in Römpp Lexikon Lacke und Druckfarben, Georg Thieme Verlag, Stuttgart, N.Y., 1998, “Thickeners”, pages 599 to 600, and in the textbook “Lackadditive” by Johan Bieleman, Wiley-VCH, Weinheim, N.Y., 1998, pages 51 to 59 and 65; especially combinations of ionic and nonionic thickeners, as described in patent application DE 198 41 842 A1 for establishing a pseudoplastic behavior, or the combination of polyurethane-based associative thickeners and polyurethane-based wetting agents, as is described in detail in German Patent Application DE 198 35 296 A1.

Further examples of suitable additives are described in the textbook “Lackadditive” by Johan Bieleman, Wiley-VCH, Weinheim, N.Y., 1998. They are employed in the customary and known amounts.

The preparation from the above-described constituents of the color and/or effect powder slurries for use in accordance with the invention also has no special features but instead takes place essentially as described in detail in the patent applications DE 195 40 977 A1, DE 195 18 392 A1, DE 196 17 086 A1, DE-A-196 13 547, DE 196 18 657 A1, DE 196 52 813 A1, DE 196 17 086 A1, DE-A-198 14 471 A1, DE 198 41 842 A1 or DE 198 41 408 A1, except that in the context of the present invention pigments are processed as well.

In a first preferred variant of the preparation, the starting material is a color and/or effect powder coating material which is prepared as in the product information bulletin from BASF Lacke+Farben AG, “Pulverlacke”, 1990 or the BASF Coatings AG document “Pulverlacke, Pulverlacke für industrielle Anwendungen”, January 2000, by homogenization and dispersion, using for example an extruder or screw kneading apparatus, and milling. After the powder coating materials have been prepared, they are prepared for dispersion by further milling and, if appropriate, by classifying and sieving.

Subsequently, the color and/or effect powder slurry can be prepared from the powder coating material by wet milling or by stirred incorporation of dry-milled powder coating material. Particular preference is given to wet milling.

In another preferred variant, the constituents described above are emulsified in an organic solvent to give an emulsion of the oil-in-water type, after which the organic solvent is removed; as a result of this, the emulsified droplets solidify to give the color and/or effect powder slurry for use in accordance with the invention. If desired, it may further be subjected to wet milling in order to improve its filterability.

In a third preferred variant, a liquid melt of the constituents described above together with the unmelted pigments is introduced into an emulsifying apparatus, preferably with the addition of water and stabilizers, and the emulsion obtained is cooled and filtered, giving the color and/or powder slurry for use in accordance with the invention. In order to achieve a high quality of mixing, it is essential to carry out mixing in the melt without solvent. Accordingly, the polymeric constituents are fed into the dispersing apparatus in the form of viscous resin melts.

Viewed in terms of its method, the mixing of one of the above-described powder slurry clearcoat materials (A) and at least one of the above-described color and/or effect powder slurries (B) or of one of the above-described color and/or effect powder slurries (A) and at least one of the above-described color and/or effect powder slurries (B) in the context of the preparation process or tinting process of the invention has no special features but instead takes place with the aid of customary and known mixing equipment such as stirred vessels, dissolvers or extruders. Mixing takes place ideally by hand, especially when preparing very small amounts.

The proportion of (A) to (B) here may vary very widely and is guided in particular by the shades and/or by the optical effects required. In an individual case, the skilled worker is readily able to determine the proportion on the basis of his or her general knowledge in the art and with the aid of rangefinding tinting tests.

Furthermore, more than one color and/or effect powder slurry (B) may be employed in the preparation or tinting process of the invention. Where two or more color and/or effect powder slurries (B) are used, they have shades and/or optical effects which differ from one another and from those of the color and/or effect powder slurry (A). As a result, it is possible from the outset, or subsequently, to adjust the shades and/or optical effects of the powder slurries of the invention with particular precision and without great effort. It is thereby possible to prepare, simply, powder slurries of the invention in a very wide variety of colors and/or intensity of optical effects, as and when required and in the particular amounts required. It is therefore also possible to forgo the preparation of large quantities of powder slurries having particular shades and/or optical effects, as a result of which the disposal problems which occur, if any, are reduced.

A further advantage of the preparation process and tinting process of the invention is that even excess color and/or effect powder slurries and powder clearcoat materials or off-specification batches which can no longer be used can now still be used for the preparation of the powder slurries of the invention and therefore need not be disposed of.

It is a very essential advantage of the powder slurries of the invention and of the preparation process and tinting process of the invention that they may be prepared and carried out, respectively, with the aid of a mixer system.

The mixer system comprises a color and/or effect powder slurry (A) and at least one color and/or effect powder slurry (B) having a different shade and/or optical effect than the powder slurry (A). Furthermore, the mixer system may also include a powder slurry clearcoat material (A). The basic principle of the mixer system is that a very large number, e.g., several thousand, of shades and/or optical effects may be mixed using a limited number of color and/or effect powder slurries (A) and (B). Surprisingly, from 10 to 50 powder slurries imparting different colors and/or effects are sufficient to give, for example, virtually all of the shades and/or optical effects that are customary in automotive OEM finishing or automotive refinishing.

The mixer system of the invention is preferably configured in the form of the modular system of the invention.

This modular system comprises an effect module (I), comprising a color and/or effect powder slurry (A), and at least one effect module (II), comprising a color and/or effect powder slurry (B). Regarding the number of the effect modules (I) and (II), the comments made above apply analogously. Furthermore, the modular system of the invention may comprise a clearcoat module (Iv), comprising a powder slurry clearcoat material (A).

An essential functional component (III) of the modular system of the invention is the paint mixing formula system (C). This system is drawn up on the basis of the powder slurries (A) and (B) which impart different colors and/or effects, and, if appropriate, of the powder slurry clearcoat material (A), and is documented in the form of recipes of the powder slurries of the invention and of standardized samples of the coatings produced from the individual powder slurries of the invention.

The powder slurries of the invention, especially those prepared by the preparation process of the invention, subsequently adjusted by the tinting process of the invention and/or prepared with the aid of the mixer system or modular system of the invention, are outstandingly suitable for all end uses for which color and/or effect powder slurries are normally used. In particular, they are suitable for automotive OEM finishing, automotive refinishing, the interior and exterior painting of constructions, the coating of doors, windows and furniture, and also industrial coating, including coil coating, container coating and the impregnation and/or coating of electrical components.

In this context they are suitable in particular for the production of color and/or effect primers, surfacers, solid-color and/or effect topcoats or basecoats, or combination effect coats, which are able to take on two or more of these functions, for the primed and unprimed substrates as normally used in the technical fields referred to above.

They may be applied without problems. The applied films exhibit excellent leveling. They can be cured using all customary and known apparatus and techniques of thermal curing and/or of curing with actinic radiation. The resultant coatings exhibit brilliant colors and/or intense optical effects and are free from surface defects.

### EXAMPLES

### Preparation Example 1

The Preparation of a White Powder Slurry

For the preparation of the white powder slurry, first of all a white powder coating material was prepared from 46.9 parts by weight of a solid epoxy resin (DOW® E.R. 642 U-20, 100%, from Dow, Schwalbach), 20.85 parts by weight of a phenolic hardener, prepared from an epoxy resin and an excess of Bisphenol A (DOW® E.H. 82, 100%, from Dow, Schwalbach) and 31.25 parts by weight of Titanium Rutil 2310 (commercially customary titanium dioxide paint pigment from Kronos International) by extruding the constituents and milling the resulting mixture.

The white powder slurry was prepared from the following constituents by mixing:

| | |
|---|---|
| 62.48 | parts by weight of deionized water, |
| 0.5 | part by weight of Acrysol ® RM-8 (nonionic |
| | thickener based on a water-soluble |
| | polyurethane, from Rohm and Haas; 35 percent |
| | strength), |
| 1.0 | part by weight of Disperse Ayd ® W-22 |
| | (anionic/nonionic wetting agent from Krahn |
| | Chemie, Hamburg; 35 percent strength in |
| | water/propylene glycol), |
| 0.02 | part by weight of Triton ® × 100 (nonionic |
| | surfactant, octylphenoxypolyethoxyethanol from |
| | Union Carbide), |
| 36.0 | parts by weight of the white powder coating |
| | material, and |
| 0.05 | part by weight of Byk ® 345 (polyether-modified |
| | polydimethylsiloxane from Byk Chemie). |

50% of the solid particles of the white powder slurry had a size <5.5 μm.

### Preparation Example 2

The Preparation of a Black Powder Slurry

For the preparation of the black powder slurry, first of all a black powder coating material was prepared from 64.8 parts by weight of the epoxy resin of Preparation Example 1, 30.2 parts by weight of the phenolic hardener from Preparation Example 1 and 5.0 parts by weight of Printex® U (carbon black pigment from Degussa) by extruding the constituents and milling the resulting mixture.

The black powder slurry was prepared from the following constituents by mixing:

| | |
|---|---|
| 62.48 | parts by weight of deionized water, |
| 0.5 | part by weight of Acrysol ® RM-8 (nonionic |
| | thickener based on a water-soluble |
| | polyurethane, from Rohm and Haas; 35 percent |
| | strength), |
| 1.0 | part by weight of Disperse Ayd ® W-22 |
| | (anionic/nonionic wetting agent from Krahn |
| | Chemie, Hamburg; 35 percent strength in |
| | water/propylene glycol), |
| 0.02 | part by weight of Triton ® × 100 (nonionic |
| | surfactant, octylphenoxypolyethoxyethanol from |
| | Union Carbide), |
| 36.0 | parts by weight of the black powder coating |
| | material, and |
| 0.05 | part by weight of Byk ® 345 (polyether-modified |
| | polydimethylsiloxane from Byk Chemie). |

50% of the solid particles of the black powder slurry had a size <5.5 μm.

### Preparation Example 3

The Preparation of a Yellow Powder Slurry

For the preparation of the yellow powder slurry, first of all a yellow powder coating material was prepared from 51.1 parts by weight of the epoxy resin of Preparation Example 1, 23.9 parts by weight of the phenolic hardener from Preparation Example 1 and 25 parts by weight of Bayferrox® 3910 (iron oxide pigment from Karl Ansberger, Cologne) by extruding the constituents and milling the resulting mixture.

The yellow powder slurry was prepared from the following constituents by mixing:

| | |
|---|---|
| 62.48 | parts by weight of deionized water, |
| 0.5 | part by weight of Acrysol ® RM-8 (nonionic |
| | thickener based on a water-soluble |
| | polyurethane, from Rohm and Haas; 35 percent |
| | strength), |
| 1.0 | part by weight of Disperse Ayd ® W-22 |
| | (anionic/nonionic wetting agent from Krahn |
| | Chemie, Hamburg; 35 percent strength in |
| | water/propylene glycol), |
| 0.02 | part by weight of Triton ® × 100 (nonionic |
| | surfactant, octylphenoxypolyethoxyethanol from |
| | Union Carbide), |
| 36.0 | parts by weight of the yellow powder coating |
| | material, and |
| 0.05 | part by weight of Byk ® 345 (polyether-modified |
| | polydimethylsiloxane from Byk Chemie). |

50% of the solid particles of the yellow powder slurry had a size <5.5 μm.

### Examples 1 to 5

the Preparation of Inventive Powder Slurries

### Example 1

An inventive powder slurry with a beige shade was prepared by mixing 90.1 parts by weight of the white powder slurry of Preparation Example 1, 7.2 parts by weight of the yellow powder slurry of Preparation Example 3 and 2.7 parts by weight of the black powder slurry of Preparation Example 2.

### Example 2

An inventive powder slurry with a light gray shade was prepared by mixing 97.1 parts by weight of the white powder slurry of Preparation Example 1 and 2.9 parts by weight of the black powder slurry of Preparation Example 2.

### Example 3

An inventive powder slurry with a pale yellow shade was prepared by mixing 45.1 parts by weight of the white powder slurry of Preparation Example 1 and 54.9 parts by weight of the yellow powder slurry of Preparation Example 3.

### Example 4

An inventive powder slurry with a dark yellow shade was prepared by mixing 90.8 parts by weight of the yellow powder slurry of Preparation Example 3, 3.5 parts by weight of the white powder slurry of Preparation Example 1 and 5.7 parts by weight of the black powder slurry of Preparation Example 2.

### Example 5

An inventive powder slurry with a dark gray shade was prepared by mixing 95.3 parts by weight of the black powder slurry of Preparation Example 2, 3.8 parts by weight of the white powder slurry of Preparation Example 1 and 0.9 part by weight of the yellow powder slurry of Preparation Example 3.

The inventive powder slurries of Examples 1 to 5 were simple to prepare. The reproducibility of the shades was outstanding. The inventive powder slurries were applied to steel panels which had been coated with a customary and known electrodeposition coating. The leveling of the resultant powder slurry films was outstanding. Baking resulted in beige (Example 1), light gray (Example 2), pale yellow (Example 3), dark yellow (Example 4) and dark gray (Example 5) coatings which were in accordance with the predetermined specifications and were free from surface defects.

1. A color and/or effect powder slurry comprising a mixture product of one of:
(A1) a powder slurry clearcoat material with
(B) at least one color and/or effect powder slurry,
or alternatively
(A2) a color and/or effect powder slurry with
(B) at least one color and/or effect powder slurry having at least one of a different shade and an optical effect than the powder slurry (A2).

2. The powder slurry of claim 1, wherein the optical effects comprises at least one of a metallic effects and a dichroic optical effects.

3. The powder slurry of claim 1, wherein the powder slurry clearcoat material (A1), the color and/or effect powder slurry (A2) and the color and/or effect powder slurry (B) are curable by at least one of thermally and with actinic radiation.

4. The powder slurry of claim 1, wherein the powder slurry clearcoat material (A1), the color and/or effect powder slurry (A2), and the color and/or effect powder slurry (B) comprise the same constituents except for the color and/or effect pigment.

5. A process for preparing the color and/or effect powder slurry of claim 1 comprising mixing one of
(A1) a powder slurry clearcoat material with
(B) at least one color and/or effect powder slurry,
or alternatively
(A2) a color and/or effect powder slurry with
(B) at least one color and/or effect powder slurry having at least one of a different shade and optical effect than the powder slurry (A2).

6. The process of claim 5, wherein the optical effects comprises at least one of a metallic effects and a dichroic optical effects.

7. The process of claim 5, wherein the powder slurry clearcoat material (A1), the color and/or effect powder slurry (A2), and the color and/or effect powder slurry (B) are curable by at least one of thermally and with actinic radiation.

8. The process of claims 5, wherein the powder slurry clearcoat material (A1), the color and/or effect powder slurry (A2), and the color and/or effect powder slurry (B) comprise the same constituents except for the color and/or effect pigments.

9. A process for subsequent adjustment of least one of a shades and an optical effects of a color and/or effect powder slurry, comprising mixing
(A) a color and/or effect powder slurry with
(B) at least one color and/or effect powder slurry having at least one of a different shade and an optical effect than the powder slurry (A).

10. The process of claim 9, wherein the optical effects comprises at least one of a metallic effects and a dichroic optical effects.

11. The process of claim 9, wherein the color and/or effect powder slurry (A) and the color and/or effect powder slurry (B) are curable by at least one of thermally and with actinic radiation.

12. The process of claims 9, wherein the color and/or effect powder slurry (A) and the color and/or effect powder slurry (B) comprise the same constituents except for the color and/or effect pigments.

13. A mixer system, for preparing color and/or effect powder slurries and/or for subsequently adjusting their shades and/or their optical effects, comprising
(A) a color and/or effect powder slurry and
(B) at least one further color and/or effect powder slurry having at least one of a different shade and an optical effect than the powder slurry (A).

14. The mixer system of claim 13, wherein the optical effects comprises at least one of a metallic effects and a dichroic optical effects.

15. The mixer system of claim 13, wherein the color and/or effect powder slurry (A) and the color and/or effect powder slurry (B) are curable by at least one of thermally and with actinic radiation.

16. The mixer system of claims 13, wherein the color and/or effect-powder slurry (A) and the color and/or effect powder slurry (B) comprise the same constituents except for the color and/or effect pigments.

17. The mixer system of claims 13, further comprising at least one powder slurry clearcoat material (A).

18. A modular system, for preparing color and/or effect powder slurries and/or for subsequently adjusting their shades and/or their optical effects, comprising
(I) an effect module comprising a color and/or effect powder slurry (A), and
(II) at least one further effect module comprising a color and/or effect powder slurry (B) having at least one of a different shade and an optical effect than the powder slurry (A), and also
(III) a paint mixing formula system (C).

19. The modular system of claim 18, wherein the optical effects comprises at least one of a metallic effects and a dichroic optical effects.

20. The modular system of claim 18, wherein the color and/or effect powder slurry (A) and the color and/or effect powder slurry (B) are curable by at least one of thermally and with actinic radiation.

21. The modular system of claims 18, wherein the color and/or effect powder slurry (A) and the color and/or effect powder slurry (B) comprise the same constituents except for the color and/or effect pigments.

22. The modular system of claims 18, further comprising at least one clearcoat module (IV) comprising a powder slurry clearcoat material (A1).

23. The color and/or effect powder slurry of claims 1, wherein a coating product of the color and/or effect powder slurry is one of an automotive OEM finish, an automotive refinish, an interior coating of a construction, and exterior coating of a constructions, a doors coating, a windows coating, furniture coating, and industrial coating, a coil coating, a container coating, and electrical component impregnation, and an electrical components coating.
